(19) United States
(12) Patent Application Publication
(10) Pub. No.: US 2012/0006174 A1
(43) Pub. Date: Jan. 12, 2012

(54) ROTARY CUTTING APPARATUS AND METHOD

(75) Inventor: Jerry M. Parks, Granville, OH (US)

(73) Assignee: OWENS CORNING INTELLECTUAL CAPITAL, LLC, Toledo, OH (US)

(21) Appl. No.: 13/180,732

(22) Filed: Jul. 12, 2011

Related U.S. Application Data
(60) Provisional application No. 61/363,494, filed on Jul. 12, 2010.

(51) Int. Cl. B26D 1/12

(52) U.S. Cl. 83/663

(57) ABSTRACT

A rotary cutting apparatus includes a support assembly, a rotary cutter connected to the support assembly, and a slide pad connected to the rotary cutter. The rotary cutter is configured to cut low density fibrous material having an area of relatively heavier density and an area of relatively lighter density. The slide pad moves relative to and along an axial direction of the rotary cutter to compress the fibrous material to a desired compression when one of the areas of relatively heavier density and lighter density is proximate to the slide pad. As the fibrous material moves relative to the slide pad such that the other of the areas of relatively heavier density and lighter density is proximate to the slide pad, the slide pad moves along the axial direction, based on the density of the fibrous material proximate to the slide pad, to substantially maintain the desired compression of the fibrous material.

This application claims the benefit of U.S. Provisional Application No. 61/363,494, filed Jul. 12, 2010, which is hereby incorporated by reference.

### BACKGROUND

The present invention relates to a rotary cutting device. It finds particular application in conjunction with a rotary cutting device for cutting low density fibrous materials and will be described with particular reference thereto. It will be appreciated, however, that the invention is also amenable to other applications.

Boards and mats made from low density fibrous materials, such as for example fiberglass fibers, may be cut into many shapes for various applications. In some instances, the boards and mats have variations in the pattern of the fibrous material resulting in different areas of heavier or lighter density. The different areas of heavier or lighter density can pose difficulties in cutting the boards and mats.

The present invention provides a new and improved apparatus and method.

### SUMMARY

In one aspect of the present invention, it is contemplated that a rotary cutting apparatus includes a support assembly, a rotary cutter connected to the support assembly, and a slide pad connected to the rotary cutter. The rotary cutter is configured to cut low density fibrous material having an area of relatively heavier density and an area of relatively lighter density. The slide pad moves relative to and along an axial direction of the rotary cutter to compress the fibrous material to a desired compression when one of the areas of relatively heavier density and lighter density is proximate to the slide pad. As the fibrous material moves relative to the slide pad such that the other of the areas of relatively heavier density and lighter density is proximate to the slide pad, the slide pad moves along the axial direction, based on the density of the fibrous material proximate to the slide pad, to substantially maintain the desired compression of the fibrous material.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a cross-sectional view of a rotary cutting apparatus, partially in phantom, in accordance with one embodiment of an apparatus illustrating principles of the present invention;

FIG. 2A illustrates an exploded cross-sectional view, partially in phantom, of the rotary cutting apparatus of FIG. 1;

FIG. 2B illustrates a plan view of a clamping member of the rotary cutting apparatus of FIG. 1;

FIG. 3 illustrates a schematic representation of a cross-sectional view of the rotary cutting apparatus of FIG. 1 shown cutting a blanket of low density fibrous material;

FIG. 4 illustrates a schematic representation of a cross-sectional view of a second embodiment of a slide pad of the rotary cutting apparatus of FIG. 1;

FIG. 5 illustrates a side view, in elevation, of a second embodiment of a compression member of the rotary cutting apparatus of FIG. 1;

FIG. 6 is a cross-sectional view of a third embodiment of a compression member of the rotary cutting apparatus of FIG. 1; and

FIG. 7 illustrates a schematic representation of a cross-sectional view, partially in phantom, of a second embodiment of a rotary cutting apparatus illustrating a weighted slide pad.

### DETAILED DESCRIPTION OF ILLUSTRATED EMBODIMENT

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose rotary cutting apparatus configured to cut boards and mats made from low density fibrous materials. The term “rotary cutter”, as used herein, is defined to mean a cutting mechanism having a cutting bit configured for rotation. The term “low density”, as used herein, is defined to mean materials having a density in a range of from about 2.0 pounds per cubic foot (pcf) to about 8.0 pcf. The term “fibrous”, as used herein, is defined to mean containing fibers.

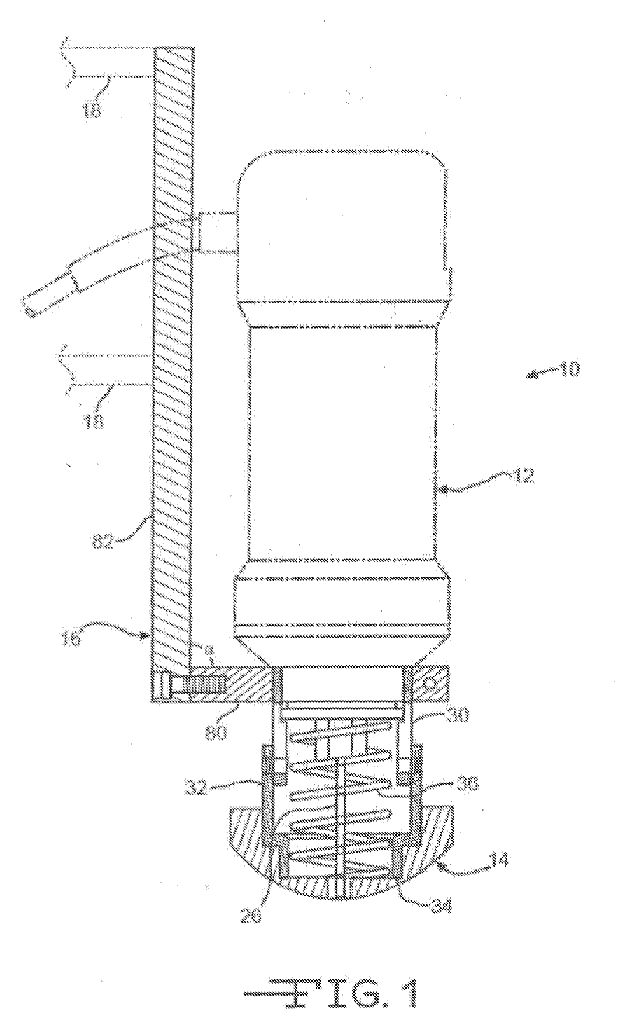

With reference to FIG. 1, a first embodiment of a rotary cutting apparatus is shown generally at 10. Generally, the rotary cutting apparatus 10 is configured to compress and cut boards and mats made from low density fibrous material. The rotary cutting apparatus 10 is further configured to compress and cut areas of the low density fibrous material having heavier or lighter density.

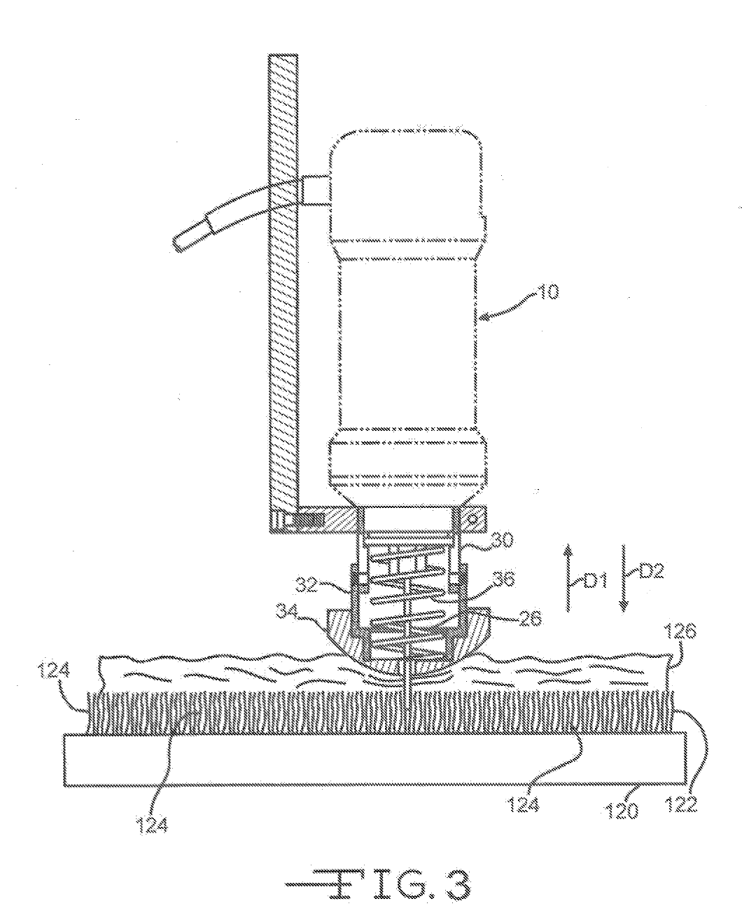

The rotary cutting apparatus 10 includes a rotary cutter 12, a head assembly 14, and a support assembly 16. Generally, the support assembly 16 is configured to position the rotary cutter 12 and the head assembly 14 such that the head assembly 14 is in contact with and compresses the low density fibrous material to a desired compression as the rotary cutter 12 cuts the low density fibrous material. In one embodiment, the desired compression results in the fibrous material (e.g., blanket 126 (see FIG. 3)) being compressed to about ½ the thickness relative to the a free state of the fibrous material. The free state of the fibrous material refers to the thickness of the fibrous material when the fibrous material is not compressed. It is contemplated that the free state is about ½″, about 1″, about 1½″, and about 2″ in respective embodiments (so that the desired compression is about ¼″, about ½″, about ¾″, and about 1″, respectively).

The rotary cutting apparatus 10 is supported by framework 18. In some embodiments, the framework 18 is connected to and controlled by computer-based machine controls (not shown) configured to control the movement of the rotary cutting apparatus 10. In other embodiments, the framework 18 is connected to other control systems, including manually controlled systems, configured to control the movement of the rotary cutting apparatus 10.

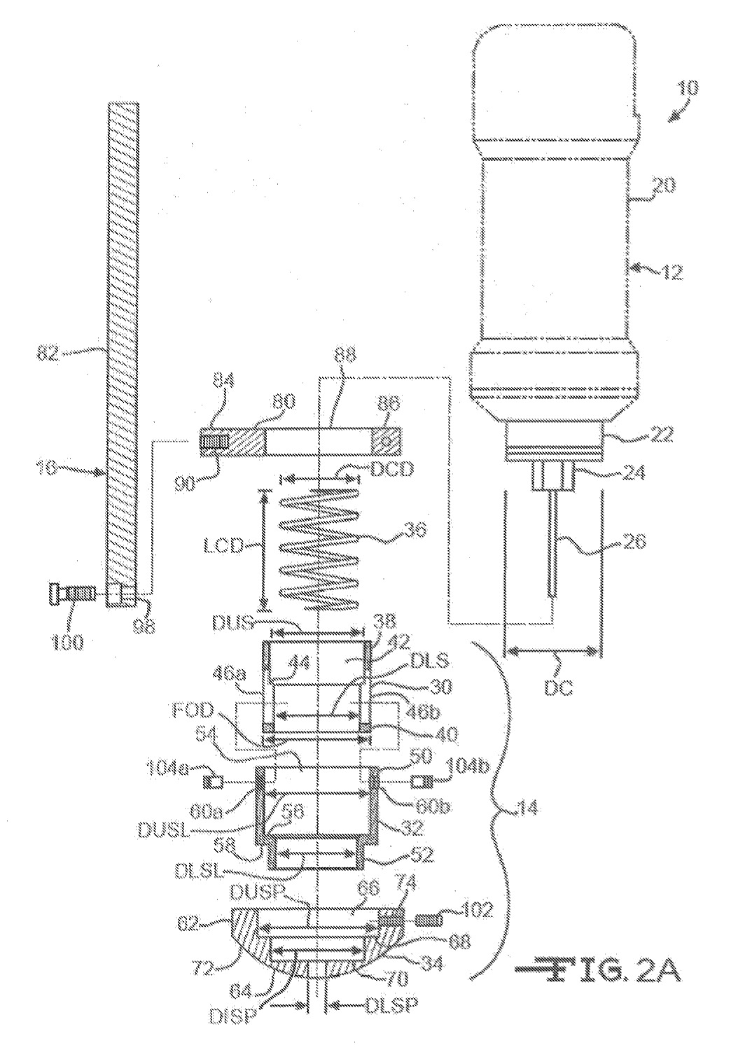

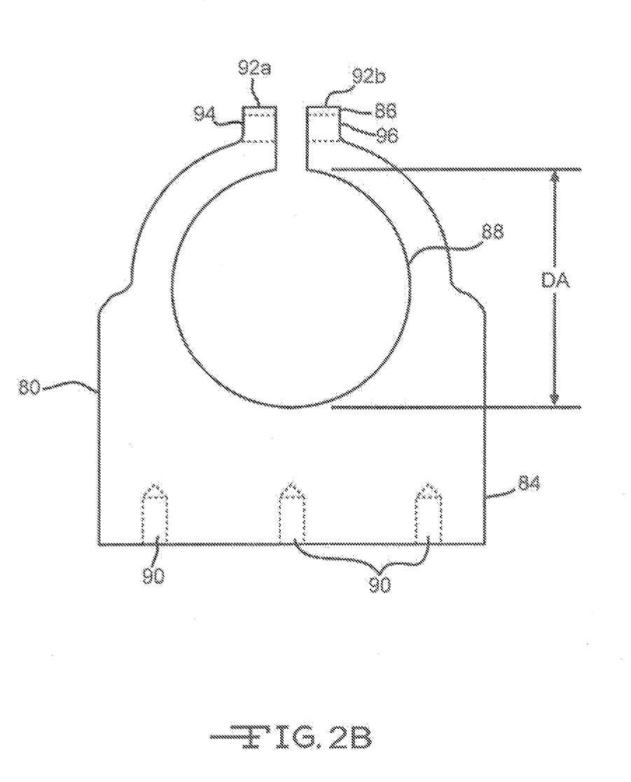

With reference to FIG. 2A, the rotary cutting apparatus 10 is illustrated in an exploded view. As discussed above, the rotary cutting apparatus 10 includes a rotary cutter 12, a head assembly 14, and a support assembly 16. The rotary cutter 12 includes a main body 20, a collar 22, a chuck 24, and a bit 26. The bit 26 is secured to the rotary cutter 12 by the chuck 24 and configured to cut the low density fibrous material. The bit 26 and the chuck 24 are rotated by a drive mechanism (not shown) positioned within the main body 20 of the rotary cutter 12. In the illustrated embodiment, the drive mechanism is an electric motor. Alternatively, the drive mechanism is other structures, devices and mechanisms, including the non-limiting example of compressed-air drive mechanism, configured to rotate the bit 26 and the chuck 24. In the illustrated embodiment, the drive mechanism is configured to drive the bit 26 at a variable rotational speed in a range of from about 15,000 revolutions per minute (rpm) to about 30,000 rpm. Alternatively, the drive mechanism is configured to drive the bit 26 at a rotational speed less than about 15,000 rpm or more than about 30,000 rpm. One example of a rotary cutter 20 is the RotoZip RZ20 marketed by the Robert Bosch Tool Corporation, headquartered in Mount Prospect, Ill. However, it should be appreciated that other rotary cutters can also be used.

The collar 22 is a non-rotating portion of the rotary cutter 12. As will be explained in more detail below, the rotary cutter 12 is secured to the support assembly 16 by clamping the collar 22 within a portion of the support assembly 16. In the illustrated embodiment, the collar 22 has a circular cross-sectional shape that generally corresponds to a circular aperture of the support assembly 16. In other embodiments, the collar 22 has other cross-sectional shapes corresponding to portions of the support assembly 16. The collar 22 has a diameter DC.

The head assembly 14 is configured to contact and compress the low density fibrous material as the rotary cutter 12 cuts the low density fibrous material. The head assembly 14 includes a support tube 30, a slide tube 32, a slide pad 34, and the compression device 36 (compression member).

The support tube 30 has an upper portion 38, a lower portion 40, and an internal bore 42 extending from the upper portion 38 to the lower portion 40. In the illustrated embodiment, the internal bore 42 has a circular cross-sectional shape. In other embodiments, the internal bore 42 has other cross-sectional shapes. The internal bore 42 at the upper portion 38 of the support tube 30 has an internal diameter DUS, and the internal bore 42 at the lower portion 40 of the support tube 30 has an internal diameter DLS. The internal diameter DUS of the upper portion 38 is larger than the internal diameter DLS of the lower portion 40, thereby creating a shoulder 44 within the internal bore 42 of the support tube 30. In the illustrated embodiment, the internal diameter DUS is approximately 1.71 inches (4.34 cm), and the internal diameter DLS is approximately 1.61 inches (4.09 cm). In other embodiments, the internal diameter DUS is more or less than approximately 1.71 inches (4.34 cm), and the internal diameter DLS is more or less than approximately 1.61 inches (4.09 cm).

The support tube 30 further includes opposing slots 46a and 46b positioned in portions of the upper portion 38 and lower portion 40 of the support tube 30. The slots 46a and 46b will be discussed in more detail below.

The slide tube 32 has an upper portion 50, a lower portion 52 and an internal bore 54 extending from the upper portion 50 to the lower portion 52. In the illustrated embodiment, the internal bore 54 has a circular cross-sectional shape. In other embodiments, the internal bore 54 has other cross-sectional shapes. The internal bore 54 at the upper portion 50 of the slide tube 32 has an internal diameter DUSL and the internal bore 54 at the lower portion 52 of the slide tube 32 has an internal diameter DLSL. The internal diameter DLSL of the lower portion 52 is smaller than the internal diameter DUSL of the upper portion 50, thereby creating a first shoulder 56 within the internal bore 54 of the slide tube 32 and a second shoulder 58 external to the slide tube 32. In the illustrated embodiment, the internal diameter DUSL is approximately 1.92 inches (4.88 cm), and the internal diameter DLSL is approximately 1.50 inches (3.81 cm). In other embodiments, the internal diameter DUSL is more or less than approximately 1.92 inches (4.88 cm), and the internal diameter DLSL is more or less than approximately 1.50 inches (3.81 cm).

The slide tube 32 further includes opposing threaded apertures 60a and 60b positioned in the upper portion 50 of the slide tube 32. The threaded apertures 60a and 60b are discussed in more detail below.

The slide pad 34 has an upper portion 62, a lower portion 64, and an internal bore 66 extending from the upper portion 62 to the lower portion 64. In the illustrated embodiment, the internal bore 66 has a circular cross-sectional shape. In other embodiments, the internal bore 66 has other cross-sectional shapes. The internal bore 66 at the upper portion 62 of the slide pad 34 has an internal diameter DUSP, and the internal bore 66 at the lower portion 64 of the slide pad 34 has an internal diameter DLSP. The internal bore 66 has an intermediate diameter DISP that extends from the internal diameter DUSP of the upper portion 62 to the internal diameter DLSP of the lower portion 64.

The internal diameter DUSP of the upper portion 62 is larger than the intermediate diameter DISP, thereby creating a first shoulder 68 within the internal bore 66 of the slide pad 34. Similarly, the intermediate diameter DISP is larger than the internal diameter DLSP of the lower portion 64, thereby creating a second shoulder 70 within the internal bore 66 of the slide pad 34. In the illustrated embodiment, the internal diameter DUSP is approximately 2.21 inches (5.61 cm), the internal diameter DISP is approximately 1.73 inches (4.39 cm), and the internal diameter DLSP is approximately 0.3 1 inches (0.79 cm). In other embodiments, the internal diameter DUSP is more or less than approximately 2.21 inches (5.61 cm), the internal diameter DISP can be more or less than approximately 1.73 inches (4.39 cm), and the internal diameter DUSP can be more or less than approximately 0.31 inches (0.79 cm).

The lower portion 64 of the slide pad 34 has an outer surface 72. In the illustrated embodiment, the outer surface 72 has an arcuate cross-sectional shape. In one embodiment, the arcuate cross-sectional shape of the outer surface 72 has a spherical radius of about 1.83″. Alternatively, the outer surface 72 can have other cross-sectional shapes, including the non-limiting example of a parabolic cross-sectional shape (see FIG. 4).

The slide pad 34 further includes a threaded aperture 74 in the upper portion 62. The threaded aperture 74 is discussed in more detail below.

In operation, the support tube 30 and the slide tube 32 are configured to slidably mate with each other, and the slide pad 34 is configured to compressibly slide along the low density fibrous material. In the illustrated embodiment, the support tube 30, the slide tube 32, and the slide pad 34 are made from a polymeric material, such as for example polyvinyl chloride (pvc) or high molecular weight polyethylene. In other embodiments, the support tube 30, the slide tube 32, and the slide pad 34 are made from other materials, including metallic materials (e.g., aluminum). In certain embodiments, the support tube 30, the slide tube 32, and the slide pad 34 have low friction coatings (e.g., Teflon®).

Referring now to FIGS. 1 and 2A, the compression device 36 is configured for positioning within the internal bore 42 of the support tube 30, within the internal bore 54 of the slide tube 32 and within the intermediate diameter DISP of the slide pad 34. In this position, the compression device 36 is configured to provide a resistive force to the movement of the slide pad 34 such that the slide pad 34 compresses the low density fibrous material and/or blanket 126 (see FIG. 3) to the desired compression during the cutting process. In one embodiment, the compression device 36 is biased to move the slide pad 34 to an extended position along the axis. A compressive force applied between the slide pad 34 and the fibrous material and/or blanket 126 (see FIG. 3) causes the slide pad 34 to move, along the axis, away from the extended position to compress the fibrous material and/or blanket 126 (see FIG. 3), which is proximate to the slide pad 34, to the desired compression. The fibrous material and/or blanket 126 (see FIG. 3) proximate to the slide pad 34 is that portion of the fibrous material and/or blanket 126 (see FIG. 3) immediately below and immediately surrounding the slide pad 34. It will be appreciated that the fibrous material and/or blanket 126 (see FIG. 3) immediately below the slide pad 34 is compressed more than the fibrous material and/or blanket 126 (see FIG. 3) immediately surrounding the slide pad 34. For example, the fibrous material and/or blanket 126 (see FIG. 3) immediately surrounding the slide pad 34 is deflected (compressed) less than the portion of the fibrous material and/or blanket 126 (see FIG. 3) immediately below and immediately surrounding the slide pad 34. The amount of deflection (compression) of the fibrous material and/or blanket 126 (see FIG. 3) immediately surrounding the slide pad 34 is based on the length of the fibers, whether the fibers are natural or synthetic, etc.

In the illustrated embodiment, the compression device 36 is a helical spring. However, as discussed in more detail below, in other embodiments the compression device 36 may be other structures, mechanisms, and/or devices. The compression device 36 has an external diameter DCD, a wire diameter, a free length LCD and a spring rate. In the illustrated embodiment, the external diameter DCD is approximately 1.46 inches (3.71 cm), the wire diameter is approximately 0.085 inches (0.22 cm), the free length LCD is approximately 2.5 inches (6.35 cm), and the spring rate is approximately 4.88 pounds per inch (lb/in) (272.80 kg/mm). In other embodiments, the external diameter DCD is more or less than approximately 1.46 inches (3.71 cm), the wire diameter is more or less than approximately 0.085 inches (0.22 cm), the free length LCD is more or less than approximately 2.5 inches (6.35 cm), and the spring rate is more or less than approximately 4.88 lb/in (272.80 kg/mm).

While the compression device 36 has been described above as having a certain spring rate, it is within the contemplation of this invention that the compression device 36, as illustrated in FIGS. 1-3, may be replaced with other compression devices having different spring rates. It is further within the contemplation of this invention that the compression device 36 has an adjustable spring rate.

In the illustrated embodiment, the compression device 36 is made from stainless steel. However, it should be appreciated that in other embodiments the compression device 36 may be made from other materials, including the non-limiting example of spring steel.

With reference again to FIG. 2A and as discussed above, the support assembly 16 is configured to position the rotary cutter 12 and the head assembly 14 such that the head assembly 14 is in contact with and compresses the low density fibrous material to the desired compression as the rotary cutter 12 cuts the low density fibrous material. The support assembly 16 includes a clamping member 80 and a support member 82.

With reference to FIG. 2B, the clamping member 80 includes a first end 84, a second end 86, and an aperture 88 positioned therebetween. The first end 84 of the clamping member 80 includes a plurality of threaded apertures 90. As discussed in more detail below, the plurality of threaded apertures 90 are configured to receive fasteners attaching the clamping member 80 to the support member 82. The second end 86 of the clamping member 80 includes mating jaws 92a and 92b. Mating jaw 92a includes an aperture 94, and mating jaw 92b includes a threaded aperture 96.

The aperture 88 has a diameter DA. The diameter DA of the aperture 88 generally corresponds to an exterior diameter of the upper portion 38 of the support tube 30. In the illustrated embodiment, the diameter DA of the aperture 88 is approximately 1.92 inches (4.88 cm). Alternatively, the diameter DA of the aperture 88 is more or less than approximately 1.92 inches (4.88 cm).

With reference again to FIG. 2A, the support member 82 includes a plurality of apertures 98 (for purposes of clarity only one aperture 98 is illustrated). The apertures 98 are configured to allow seating by a plurality of threaded fasteners 100 (for purposes of clarity, only one fastener 100 is illustrated). In operation, the clamping member 80 is attached to the support member 82 as the threaded fasteners 100 are inserted through the apertures 98 of the support member 82 and threaded into the threaded apertures 90 of the clamping member 80. As shown in FIG. 1, the assembled clamping member 80 and support member 82 form an angle α. In the illustrated embodiment, the angle α is approximately 90°. In other embodiments, the angle α is more or less than approximately 90°.

With reference again to FIG. 2A, in operation the rotary cutting apparatus 10 is assembled in the following steps. First, the clamping member 80 and the support member 82 are assembled as described above. Second, the slide tube 32 is assembled to the slide pad 34 by inserting lower portion 52 of the slide tube 32 into the internal diameter DISP of the slide pad 34 until the lower portion 52 of the slide tube 32 seats against the second shoulder 70 of the slide pad 34. A threaded fastener 102 is threaded into the threaded aperture 74 of the slide pad 34 and tightened against an exterior surface of the upper portion 50 of the slide tube 32. In this position, the slide tube 32 and the slide pad 34 are attached together such that movement of the slide pad 34 results in movement of the slide tube 32.

Next, the assembled slide tube 32 and slide pad 34 are attached to the support tube 30 by inserting the lower portion 40 of the support tube 30 into the internal diameter DUSL of the slide tube 32 until the lower portion 40 of the support tube 30 seats against the first shoulder 56 of the slide tube 32. Slide pins 104a and 104b are used to secure the assembly of the slide tube 32 and the slide pad 34 to the support tube 30. Each of the slide pins 104a and 104b has a dowel portion and a threaded portion. The dowel portions of the slide pins 104a and 104b are inserted through the threaded apertures 60a and 60b of the slide tube 32 and into the slots 46a and 46b of the support tube 30. The dowel portions of the slide pins 104a and 104b are securely positioned within the slots 46a and 46b of the support tube 30 as the threaded portions of the slide pins 104a and 104b are threaded into the threaded apertures 60a and 60b of the slide tube 32. As a result of this assembly, the assembled slide tube 32 and slide pad 34 are supported by the support tube 30. In this configuration, the slide tube 32 and slide pad 34 may move axially (along an axis) relative to, and defined by, the support tube 30 (and the rotary cutter 12). The distance of the axial movement in an axial direction of the assembled slide tube 32 and slide pad 34 relative to the support tube 30 is defined by the length of the slots 46a and 46b and the diameter of the dowel portion of the slide pins 104a and 104b. In the illustrated embodiment, the distance of the relative movement is in a range of from about 0.50 inches (1.27 cm) to about 0.80 inches (2.03 cm). However, it should be appreciated that in other embodiments, the distance of the relative movement is less than about 0.50 inches (1.27 cm) or more than about 0.80 inches (2.03 cm).

Following attachment of the assembled slide tube 32 and slide pad 34 to the support tube 30, the upper portion 38 of the support tube 30 is inserted into the aperture 88 of the clamping member 80. After the upper portion 38 of the support tube 30 is positioned in the aperture 88 of the clamping member 80, the compression member 36 is inserted into the internal bores 42, 54 and 66 of the support tube 30, slide tube 32, and slide pad 34, respectively. In this position, a lower portion of the compression member 36 seats against the second shoulder 70 of the slide pad 34.

Next, the bit 26 is inserted into the chuck 24 of the rotary cutter 12 and the chuck 24 is tightened to secure the bit 26. The collar 22 of the rotary cutter 12 is inserted into the internal diameter DUS of the support tube 30. A threaded fastener (not shown) is inserted through the aperture 94 of the mating jaw 92a and threaded into the threaded aperture 96 of the mating jaw 92b. The threaded fastener is tightened until the support tube 30 and the collar 22 of the rotary cutter 12 are securely held within the aperture 88.

With reference again to FIG. 1, in an assembled position, the rotary cutter 12 is secured by the clamping member 80 such that the compression member 36 urges the slide tube 32 and the slide pad 34 into the extended position relative to the support tube 30. In the extended position, the bit 26 does not extend beyond the lower portion 64 of the slide pad 34. The bit 26 extends beyond the lower portion 64 of the slide pad 34 when the slide pad 34 is not in the extended position and when the slide pad 34 is positioned along the axial direction of the rotary cutter 12 to compress the fibrous material and/or blanket 126 (see FIG. 3) to the desired compression.

With reference to FIG. 3, the rotary cutting apparatus 10 is illustrated in use. A support structure 120 is configured to provide a flat surface upon which a pad 122 is positioned. The support structure 120 may be any structure, mechanism, or device, including the non-limiting example of a table, sufficient to provide a flat surface upon which the pad 122 can be positioned. In the illustrated embodiment, the pad 122 is a low density semi-rigid material, such as for example artificial turf having a plurality of grass-like fibers 124 that extend in random directions away from the support structure 120. The pad 122 and the grass-like fibers 124 are discussed in more detail below.

A sheet or blanket 126 of low density fibrous material is positioned on the surface of the pad 122. The rotary cutting apparatus 10 is positioned over the blanket 126 of low density fibrous material such that the slide pad 34 contacts and compresses the blanket 126 of low density fibrous material. In a compressed position, the assembled slide tube 32 and slide pad 34 moves in an axial direction relative to the support tube 30 as indicated by the direction arrow D1. The axial movement of the assembled slide tube 32 and slide pad 34 in the direction D1 is resisted by the compression member 36. As the assembled slide tube 32 and slide pad 34 continues to move in the axial direction D1, the bit 26 is exposed such as to be at a cutting depth.

In a cutting position, the bit 26 extends through the blanket 126 of low density fibrous material and into the pad 122 of grass-like fibers 124. The rotary cutting apparatus 10 is moved in horizontal directions to follow a desired cutting pattern. As the rotary cutting apparatus 10 is moved, the slide pad 34 continues to be in contact with and compress the blanket 126 of low density fibrous material to the desired compression. In some embodiments, the blanket 126 of low density fibrous material can have variations in the density of the fibrous material resulting in areas of heavier or lighter density. As the slide pad 34 of the rotary cutting apparatus 10 encounters proximate areas of the fibrous material and/or blanket 126 having heavier density, the slide pad 34 is urged in the axial direction D1 (e.g., relatively away (farther) from the extended position). As the slide pad 34 of the rotary cutter apparatus 10 encounters proximate areas of the fibrous material and/or blanket 126 having lighter density, the compression member 36 urges the slide pad 34 in an axial direction D2 (e.g., relatively toward (closer to) the extended position). Accordingly, the assembled slide tube 32 and slide pad 34 are spring-loaded by the compression member 36 to adjust to the proximate areas of the low density fibrous material (e.g., the blanket 126) having variations in the density of the fibrous material. By adjusting to the (proximate) areas of the low density fibrous material (e.g., the blanket 126) having variations in the density of the fibrous material, the rotary cutting apparatus 10 is better able to maintain a substantially continuous compression (e.g., the desired compression) of the low density fibrous material and/or blanket 126, based on the lighter/heavier density of the fibrous material under the blanket 126, as the blanket 126/fibrous material is/are cut by the bit 26.

While not shown in FIG. 3, it is contemplated that the rotary cutting apparatus 10 may be moved about the blanket 126 of low density fibrous material in a non-cutting configuration. In a non-cutting configuration, the slide pad 34 is positioned above the blanket 126 such as not to contact the blanket 126 and the assembled slide tube 32 and slide pad 34 are in the extended position. As discussed above in the extended position, the bit 26 does not extend beyond the lower portion 64 of the slide pad 34, thereby providing an added safely measure for the users of the rotary cutting apparatus.

While the rotary cutting apparatus 10 is shown in FIGS. 1-3 and described above, it should be appreciated that other embodiments of the rotary cutting apparatus may be employed. Referring first to FIG. 4, a second embodiment of a slide pad is illustrated generally at 234. In this embodiment, the slide pad 234 is the same as, or similar to, the slide pad 34 described above with the exceptions that a lower portion 264 of the slide pad 234 includes a generally flat exterior center portion 266 and adjoining rounded corner portions 268. The generally flat exterior center portion 266 is configured to provide a larger area of compressed low density fibrous material during the cutting process. The rounded corner portions 268 are configured to allow the slide pad 234 to easily move over the compressed low density fibrous material and/or blanket 126 without being hindered by loose fibers. In one embodiment, the generally flat exterior center portion 266 is about 1.732″, and the rounded corner portions 268 have a radius of about 0.875″.

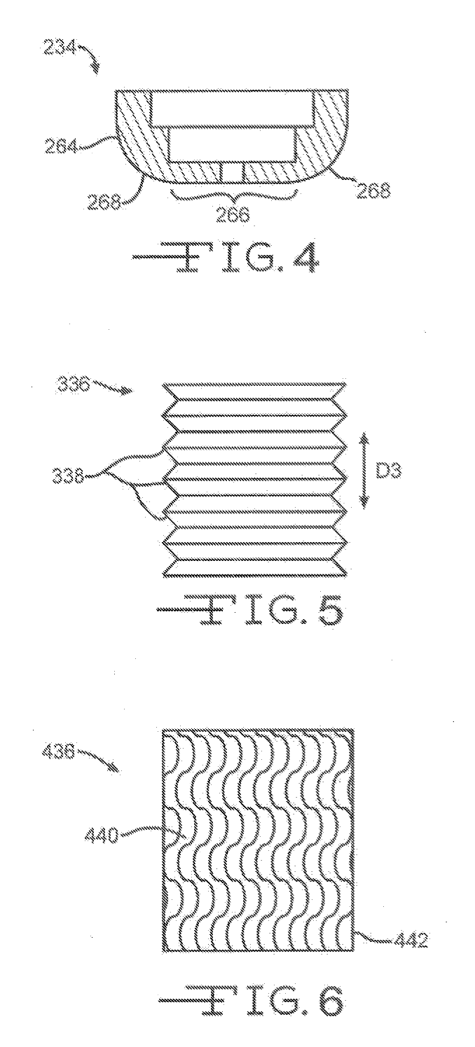

While the embodiment of the compression member 36 illustrated in FIGS. 1-3 show the compression member 36 to be a helical spring, it is within the contemplation of this invention that alternate embodiments of the compression member may be employed. Referring first to FIG. 5, a second embodiment of a compression member 336 includes a fluid-filled baffle configuration. The compression member 336 is configured as a direct replacement of the compression member 36 discussed above and illustrated in FIGS. 1-3. The compression member 336 includes a plurality of baffles 338, filled with a fluid, and configured for extension and contraction in an axial direction as indicated by arrow D3. In an extended orientation, the compression member 336 is configured to spring-load a slide pad in the same manner as discussed above for the compression member 36. In a contracted orientation, the fluid within the compression member 336 is configured to contract, thereby allowing the slide pad to move in an axially upward direction. In the illustrated embodiment, the fluid within the compression member 336 is compressed air. In other embodiments, the fluid within the compression member 336 may be other mediums, including the non-limiting example of hydraulic fluid.

With reference to FIG. 6, a third embodiment of a compression member 436 is illustrated. In this embodiment, the compression member 436 includes a compressible medium 440 contained within a flexible outer material 442. The compression member 436 is configured as a direct replacement of the compression member 36 discussed above and illustrated in FIGS. 1-3. The compressible medium 440 is configured to expand and contract according to axial movement of a slide pad. In an extended orientation, the compression member 436 is configured to spring-load a slide pad in the same manner as discussed above for the compression member 36. In a contracted orientation, the compressible medium 440 within the compression member 436 is configured to contract, thereby allowing the slide pad to move in an axially upward direction to maintain a desired compression. In the illustrated embodiment, the compressible medium 440 is a polymeric material, such as the non-limiting example of polyurethane elastomer gel. However, the compressible medium 440 may be other desired materials. In the illustrated embodiment, the flexible outer material 442 is a polymeric material, such as for example polyethylene. In other embodiments, the flexible outer material 442 can be other desired materials.

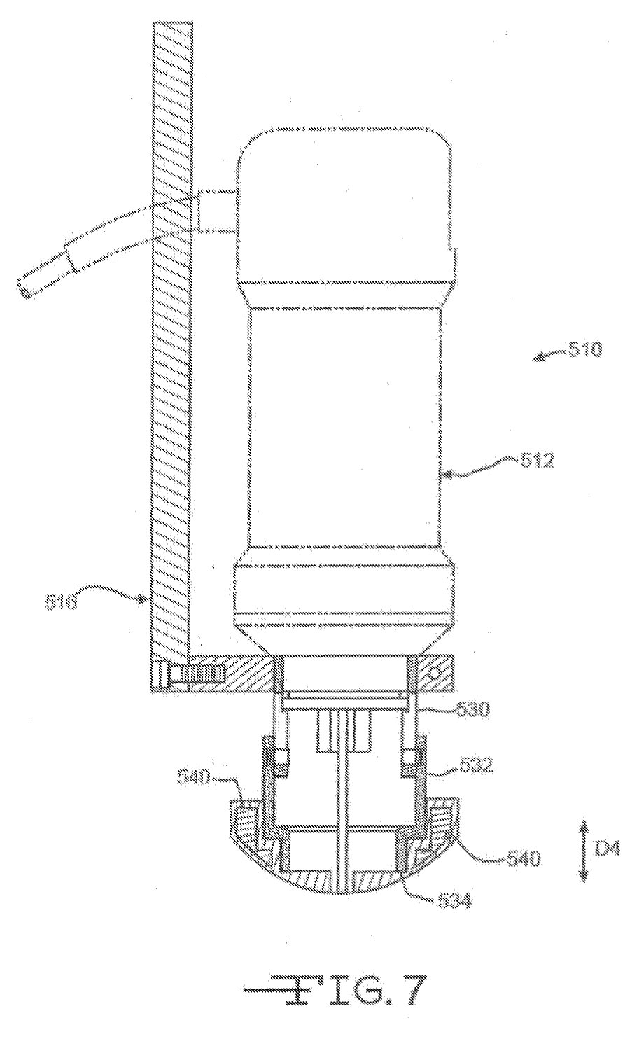

With reference to FIG. 7, another embodiment of a rotary cutting apparatus 510 is illustrated. The rotary cutting apparatus 510 includes a rotary cutter 512 support by a support assembly 516. The rotary cutter 512 includes a support tube 530 and a slide tube 532. In this embodiment, the rotary cutter 512, support assembly 516, support tube 530, and slide tube 532 are the same as, or similar to, the rotary cutter 12, support assembly 16, support tube 30, and slide tube 32 discussed above and illustrated in FIGS. 1-3. However, in this embodiment of the rotary cutting apparatus 510, the compression member has been removed. The spring-loaded action provided to a slide pad 534 is accomplished by weights 540 incorporated into the slide pad 534. In operation, as the slide pad 534 contacts and compresses a blanket of low density fibrous material, the weights 540 cause the assembled slide tube 534 and slide pad 534 to axially move relative to the support tube 530, as indicated by the direction arrow D4, in response to areas of a blanket of low density fibrous material having more or less density. In the illustrated embodiment, the weights are a dense metallic material, such as for example lead, and are incorporated within the interior of the slide pad 534. However, in other embodiments, the weights 540 may be other desired materials and can be located in other areas of the slide pad 534, such as for example on an upper surface of the slide pad 534.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A rotary cutting apparatus, the rotary cutting apparatus comprising:
a support assembly;
a rotary cutter connected to the support assembly and configured to cut low density fibrous material having an area of relatively heavier density and an area of relatively lighter density; and
a slide pad connected to the rotary cutter and moving relative to and along an axial direction of the rotary cutter to compress the fibrous material to a desired compression when one of the areas of relatively heavier density and lighter density is proximate to the slide pad, and as the fibrous material moves relative to the slide pad such that the other of the areas of relatively heavier density and lighter density is proximate to the slide pad, the slide pad moving along the axial direction, based on the density of the fibrous material proximate to the slide pad, to substantially maintain the desired compression of the fibrous material.

2. The rotary cutting apparatus as set forth in claim 1, wherein:
the slide pad is configured with spring-loaded action to allow the slide pad to move in the axial direction relative to the rotary cutter.

3. The rotary cutting apparatus as set forth in claim 2, wherein:
the slide pad is biased by the spring-loaded action to an extended position along the axial direction; and
the slide pad moves away from the extended position along the axial direction when compressing the fibrous material to the desired compression.

4. The rotary cutting apparatus as set forth in claim 3, wherein:
when the slide pad is proximate the area of relatively heavier density, the slide pad is positioned along the axial direction relatively farther from the extended position than when the slide pad is proximate the area of relatively lighter density.

5. The rotary cutting apparatus as set forth in claim 3, wherein:
the rotary cutter includes a bit for cutting the low density fibrous material;
wherein the bit does not extend beyond the slide pad when the slide pad is in the extended position; and
wherein the bit extends beyond the slide pad at a cutting depth when the slide pad is not in the extended position and when the a slide pad is positioned along the axial direction of the rotary cutter to compress the fibrous material to the desired compression.

6. The rotary cutting apparatus as set forth in claim 2, wherein the slide pad includes:
a compression device providing the spring-loaded action and a resistive force to the movement of the slide pad for compressing the low density fibrous material.

7. The rotary cutting apparatus as set forth in claim 6, wherein:
the compression device is a spring.

8. The rotary cutting apparatus as set forth in claim 6, wherein:
the compression device includes a compressible medium.

9. The rotary cutting apparatus as set forth in claim 1, wherein:
the slide pad is semi-hemispherically shaped.

10. A rotary cutting apparatus, the rotary cutting apparatus comprising:
a support assembly;
a rotary cutter connected to the support assembly and configured to cut low density fibrous material having an area of relatively heavier density and an area of relatively lighter density; and
a slide pad, positioned along an axis defined by the rotary cutter to compress the fibrous material to a desired compression, the slide pad being positioned along the axis based on a density of the fibrous material proximate the slide pad.

11. The rotary cutting apparatus as set forth in claim 10, further including:
a compression device biased to move the slide pad to an extended position along the axis, the compression device providing a resistive force to movement of the slide pad away from an extended position when compressing the low density fibrous material.

12. The rotary cutting apparatus as set forth in claim 11, wherein:
the compression device is a helical spring.

13. The rotary cutting apparatus as set forth in claim 11, wherein:
the compression device causes the slide pad to extend relatively farther from the extended position along the axis when the slide pad is positioned proximate to the area of relatively lighter density; and
the compression device causes the slide pad to extend closer to the extended position when the slide pad is positioned proximate to the area of relatively heavier density.

14. The rotary cutting apparatus as set forth in claim 11, wherein:
the rotary cutter includes a bit for cutting the low density fibrous material;
wherein the bit does not extend beyond the slide pad when the slide pad is in the extended position; and
wherein the bit extends beyond the slide pad at a cutting depth when the slide pad is not in the extended position and when the a slide pad is positioned along the axial direction of the rotary cutter to compress the fibrous material to the desired compression.

15. The rotary cutting apparatus as set forth in claim 11, wherein:
the compression device provides the slide pad with spring-loaded action to allow the slide pad to move along the axis.

16. A method of cutting low density fibrous material, the low density fibrous material having variations in the fibrous material resulting in areas of heavier or lighter density, the method comprising the steps of:
providing a rotary cutting apparatus having a support assembly configured to support a rotary cutter, the rotary cutter configured to cut the low density fibrous material, and a slide pad connected to the rotary cutter, wherein the slide pad is configured with spring-loaded action;
positioning the rotary cutting apparatus such that the slide pad compresses the low density fibrous material to a desired compression;
cutting the low density fibrous material with the rotary cutter while the fibrous material is compressed to the desired compression; and
moving the rotary cutting apparatus while maintaining compression of the low density fibrous material such that the spring-loaded action provided to the slide pad allows the slide pad to move in an axial direction in response to the areas of heavier or lighter density of the low density fibrous material.

17. The method of cutting low density fibrous material as set forth in claim 16, further including:
moving the slide pad along the axial direction to compress the low density fibrous material to the desired compression.

18. The method of cutting low density fibrous material as set forth in claim 17, further including:
moving the slide pad along the axis of the rotary cutter to maintain compression of the low density fibrous material at the desired compression.

19. The method of cutting low density fibrous material as set forth in claim 18, wherein the moving step includes:
moving the slide pad along the axial direction further from an extended position to maintain compression of the low density fibrous material at the desired compression when the slide pad moves from the area of lighter density to the area of heavier density; and
moving the slide pad along the axial direction closer to an extended position to maintain compression of the low density fibrous material at the desired compression when the slide pad moves from the area of heavier density to the area of lighter density.
